(19) United States
(12) Patent Application Publication
(10) Pub. No.: US 2006/0240168 A1
(43) Pub. Date: Oct. 26, 2006

(54) Chitosan foodstuff

(76) Inventors: Jo Klaveness, Trondheim (NO); Einar Mustaparta, Trondheim (NO); Bjarne Brudeli, Trondheim (NO); Olav Smidsrod, Trondheim (NO); Kjell Morten Varum, Trondheim (NO)

Correspondence Address: SUGHRUE MION, PLLC, 2100 PENNSYLVANIA AVENUE, N.W., SUITE 800, WASHINGTON, DC, 20037, US

(21) Appl. No.: 10/544,521

(22) PCT Filed: Feb. 6, 2004
(86) PCT No.: PCT/GB04/00437

§ 371 Date: Jun. 21, 2006

(30) Foreign Application Priority Data
Feb. 6, 2003 (GB) 0302741.4

(51) Int. Cl. A23L 1/212

(52) U.S. Cl. 426/615

(57) ABSTRACT

The invention provides a foodstuff comprising a nutritional food substance and a chitosan having an F_{A} value of at least 0.25.

The present invention relates to the use of chitosan to inhibit uptake from the gastrointestinal (GI) tract of undesirable chemical compounds present in foodstuffs or which have accidentally or mistakenly been ingested and to chitosan compositions for use in this regard.

Many foodstuffs contain compounds that are harmful to the consumer, e.g. cholesterol, acrylamide, fats, pesticide residues, additives, etc. Likewise many people accidentally (and occasionally non-accidentally) ingest harmful chemical compounds, for example drugs and toxins such as for example pesticides, anticoagulants, analgesics, narcotics, physiologically active plant compounds (e.g. digitalis which is present in foxgloves), etc. There is thus a need for products which can be consumed and then serve to reduce the availability for uptake from the GI tract of these harmful compounds or which can be formulated or administered together with the foodstuff containing the harmful compounds so as again to reduce the availability for uptake from the GI tract of these harmful compounds.

We have now surprisingly found that certain chitosans are particularly useful in this regard. More particularly we have found that the ability of chitosan to hinder uptake of undesired compounds, in particular undesired lipophilic compounds, is surprisingly dependant on the degree of acetylation F_{A} of the chitosan, which is the product of complete or partial deacetylation of chitin.

Chitin is a natural nitrogenous mucopolysaccharide of formula (C₈H₁₃NO₅)ₙ which occurs in the exoskeletons of invertebrates and also in funghi. In particular it is a major component of the exoskeletons of crustacea such as shrimp, crab, prawn and lobster. More particularly chitin is poly N-acetyl-D-glucosamine. Thus chitin consists of (1→4)-linked 2-acetamido-2-deoxy-β-D-glucose (GlcNac; the A-unit). The physical structure of chitin is highly ordered, and the most abundant form is α-chitin which is available as a waste material from the shellfish food industry. In α-chitin the chains are antiparallel, and extensively hydrogen-bonded. Another form is β-chitin, which can be isolated from, for example the pen of the squid Loligo and the spines of the diatom Thalassiosira fluviatilis. In β-chitin the chains are parallel, and the chains are less hydrogen-bonded compared with α-chitin.

Chitin is insoluble in water, even at acidic pH-values, and in most organic solvents. This has served to limit the applications for which it is used.

The N-acetyl groups in chitin can be cleaved off to yield the product known as chitosan. Chitosan has many known uses, e.g. in pharmaceutical and cosmetic compositions, and as fillers, absorbants, carriers and supports.

Chitosan may be regarded as a family of water-soluble polysaccharides consisting of (14'4)-linked A-units and units of 2-amino-2-deoxy-β-D-glucose (GlcN; the D-unit) in varying relative abundances and sequences.

The distinction here between chitin and chitosan is based on the insolubility of chitin in dilute acid solution and the solubility of chitosan in the same dilute acid solution (see Roberts, G. A. F., “Chitin Chemistry” (1991), pages 6-7).

The definition of fully water-soluble chitosan given on page 6 of Roberts (supra) is related to the fact that chitosans are generally only soluble in water when the free amino groups of D-units are protonated. Such protonation can be achieved by the addition of a controlled amount of an acid, e.g. acetic acid. However, chitosan can also be prepared in different salt forms, i.e. with a protonated amino-group in the D-units and a negatively charged counterion (e.g. formate, acetate, chloride or another negative ion), which make it soluble in water without the addition of an acid. Procedures for the preparation of such chitosan salts are described in the literature (see for example Draget et al, Biomaterials 13:635-638 (1992), Vårum et al. Carbohydrate Polymers 28:187-193 (1995), and U.S. Pat. No. 5,599,916).

One parameter used to characterize chitosans is F_{A}, the relative fraction of the saccharide units which are A rather than D units.

To illustrate the structure of chitosan, the following schematic representation of the chemical structure of three different chitosans with varying compositions of A and D-units are given:

DDDDDDDDDDDDDDDDDDDDDDDDDDDDDDDDDDDDDDDD

Part of a fully N-deacetylated chitosan molecule (F_{A}=0.00)

DDDADDADDDDDAADDADDDDDADADDDDAADDDDADDDD

Part of a partially N-acetylated chitosan molecule (F_{A}=0.25)

DAAADDADDDDAAAADADDADDADDDDADAAAADDAADAA

Part of a partially N-acetylated chitosan molecule (F_{A}=0.50)

The presence of one monomer residue with a hydrophilic and protonizable amino group and another monomer residue with a hydrophobic acetyl group, where the relative amounts of the two monomers can be varied, can affect chitosan's physical properties in solution and in the gel and solid states, as well as its interactions with other molecules, cells and other biological and non-biological matter. However, the commercial use of chitosan has so far been limited to chitosan samples with a low fraction of acetylated units (F_{A}<0.15) due partly to the lack of inexpensive methods to prepare other chitosans on a large scale, and due partly to the limited scientific understanding of the functional properties of chitosans with a higher F_{A}.

It should be noted that besides deacetylation, in the production of chitosan from chitin, depolymerisation may also occur and chitosan can be produced with a wide range of degrees of acetylation and a wide range of molecular weights. In general, however, one remaining problem with commercially available chitosan is its insolubility at physiological pH values.

The production of chitosan from chitin is generally carried out as either a homogeneous reaction or as a heterogeneous reaction. In the homogeneous reaction chitin is suspended in alkali and the suspension is cooled with ice to bring the chitin into solution; in the heterogeneous reaction particulate chitin is dispersed in a hot alkaline solution, generally sodium hydroxide. In the case of the homogeneous reaction, the F_{A} of the chitosan obtained is generally 0.3 to 0.7. In the case of the heterogeneous reaction, the F_{A} of the chitosan obtained is generally in the range of 0 to 0.15. Where a chitosan with a different degree of deacetylation is required it may be necessary to re-acetylate the chitosan. In the case of the homogeneous reaction, the remaining N-acetyl groups are generally randomly located along the polymeric backbone of the chitosan product. In the case of the heterogeneous reaction, a small fraction of insoluble chitin-like material is most often present in the product together with an acid-soluble fraction with a near random distribution of acetyl groups along the polymeric backbones.

Descriptions of prior art deacetylation procedures may be found in: U.S. Pat. No. 4,195,175; Vårum et al, pages 127-136 in “Advances in chitin chemistry”, Ed. C. J. Brine, 1992; Ottøy et al, Carbohydrate Polymers 29:17-24 (1996); Sannan et al, Macromol. Chem. 176:1191-1195 (1975); Sannan et al, Macromol. Chem. 177:3589-3600 (1976); Kurita et al, Chemistry Letters 1597-1598 (1989); and CA-A-2101079.

Enhanced performance, in several applications, has recently been found for more highly acetylated chitosan fractions (see Smidsrød et al, pages 1 to 11, in “Chitin and Chitosan—Chitin and Chitosan in Life Science”; Eds. T. Uragami et al., Kodansha Scientific, Japan (2001) (ISDN 4-906464-13-0)). Of importance is increased solubility at neutral pH-values, a controllable degradation rate by lysozymes, strong interactions with hydrophobic surfaces (e.g. fat particles and cell surfaces) thereby giving enhanced fat binding properties and flocculation, enhanced destabilisation effects on oil-in-water-emulsions, and extended utility in a number of cosmetic, nutraceutical and biomedical applications.

More highly acetylated chitosans have also recently been shown to flocculate bacterial cells more effectively (see Strand et al. Biomacromolecules 2:126-133 (2001)).

However the known procedures for preparation of more highly acetylated chitosans suffer from disadvantages which make them unsuitable for upscaling to industrial production.

Thus, for example, for the heterogeneous deacetylation process without swelling, it is necessary to extract the product with an acid in order to separate the unreacted chitin from the water-soluble chitosan; this involves removal of water in addition to reduced yield of the highly acetylated chitosan product.

The reacetylation of a highly deacetylated chitosan, in addition to the deacetylation step, involves solubilization of the chitosan, use of organic chemicals such as acetic anhydride and methanol, and isolation of the final product.

The homogeneous deacetylation procedure involves solubilisation of the chitin by addition of ice, and isolation of the chitosan from the solution. Moreover, to avoid the chitin solution having too high a viscosity, large volumes of aqueous lye are needed in the reaction medium. This homogeneous deacetylation procedure therefore results in a more expensive product compared to the product of a heterogeneous deacetylation procedure.

Advanced Biopolymers AS have recently found that if in the heterogeneous deacetylation reaction the chitin is first subjected to a prolonged low temperature alkaline swelling stage a chitosan product may be obtained with a more random distribution of residual N-acetyl groups along the polymeric chains, with a degree of deacetylation which can be as low or high as desired, with a degree of depolymerisation which may if desired be lower than in the conventional products, and if desired with an enhanced water-solubility at physiological pHs. This novel chitosan production process is described in the contents of WO 03/011912 which are incorporated herein by reference.

More particularly we have found that chitosans with higher F_{A} values, such as those prepared by the processes of WO 03/011912, are especially effective at binding undesirable lipophilic compounds such as for example cholesterol, as compared with the chitosans which are commercially available and which have F_{A} values below 0.2. It is also believed that such chitosans may act by inhibiting the enhancement of lipid micelle formation by bile salts.

Viewed from one aspect the invention provides a foodstuff comprising a nutritional food substance (e.g. a cooked or uncooked material of animal or plant origin) and a chitosan having an F_{A} value of at least 0.25, preferably at least 0.3, e.g. up to 0.9, more preferably up to 0.7, said chitosan preferably constituting 0.1 to 10% wt, more preferably 1 to 5% wt of said foodstuff.

Thus viewed from a further aspect the invention provides the use of a chitosan having an F_{A} value of at least 0.25, preferably at least 0.3, e.g. up to 0.9, more preferably up to 0.7 for the manufacture of a medicament for use in a method of treatment of a human or non-human vertebrate (e.g. mammal) subject to inhibit uptake from the gastrointestinal tract thereof of undesired chemical compounds, e.g. lipophilic compounds present in foodstuffs.

Viewed from a still further aspect the invention provides a method of treatment of a human or non-human vertebrate (e.g. mammal) subject to inhibit uptake from the gastrointestinal tract thereof of undesired chemical compounds, which method comprises administering orally to said subject an effective amount of a chitosan having an F_{A} value of at least 0.25, preferably at least 0.3, e.g. up to 0.9, more preferably up to 0.7.

The method of the invention is especially suited for the treatment of high blood fat, hyperlipemia and high blood cholesterol, hypercholesteremia or hypertriglyceridemia.

The chitosans used according to the invention may have a weight average molecular weight (M_{w}) within a very broad range, e.g. 1000 to 5000000 g/mol. Preferably however M_{w} is 10000 to 3000000 g/mol, especially 20000 to 2000000 g/mol.

Where the chitosan is formulated with a food material to produce a foodstuff according to the invention, this will preferably be a food which contains the undesired chemical compound or which is habitually eaten together with a food containing the undesired chemical compound. Thus the foodstuff may typically be a sauce, spread or condiment or a precursor for a sauce. Further preferred embodiments of the foodstuff of the invention are potato granulate (i.e. “instant mashed potato”) and potato croquettes.

The chitosan used in the compositions of the invention is preferably a fully water-soluble chitosan, particularly a chitosan soluble in water at the pH's encountered in the gastrointestinal tract, more particularly a chitosan which is water-soluble at pH's of 3 to 8, especially 5 to 8, more especially 6 to 8.

By “fully water-soluble chitosan” as used herein, is meant a chitosan that can be fully dissolved, that is more than 97% wt dissolved in a dilute acid solution, for example as a 1% w/v solution of the chitosan in 1% w/v acetic acid.

The chitosan used is preferably produced using the processes described in WO 03/011912.

Particularly desirably a combination of chitosans with different F_{A} values is used, e.g. at least two chitosans with F_{A} values differing by at least 0.1, more preferably by at least 0.2.

The chitosans used preferably have F_{A} values above 0.25; however where two or more chitosans are used one or more may have F_{A} values below 0.25, e.g. below 0.2, for example 0.05 to 0.19.

There has recently been much concern as a result of the finding that foods which are cooked at temperatures above about 150° C. contain the toxic chemical acrylamide, e.g. potato crisps, crispbread, french fries, etc. We have surprisingly found that the bioavailability of acrylamide can be significantly reduced by the use of chitosans according to the invention.

In addition to the chitosan, or less preferably in place of the chitosan, finely granulated chitin may be used in accordance with a further aspect of the invention. In this regard, a particle size of 0.1 to 500 μm, especially 1 to 100 μm is preferred.

We have also found that foodstuffs containing or foodstuffs derived from lysozymes will have the ability to degrade chitosans and thereby supply chitosan-oligomers, N-acetyl-glucosamine and glucosamines as metabolites. We have found that said metabolites are beneficial to hair, skin, joints etc.

The medicament in the preparation of which the chitosan is used may be a pharmaceutical or nutraceutical, i.e. it may contain further active ingredients besides chitosan but preferably it will contain as further active ingredients only nutritional components such as vitamins, essential minerals, amino acids, proteins, carbohydrates, and fatty acids or triglycerides.

The use of chitosan according to the invention has two particular relevant aspects relating to drug compounds.

Firstly, the chitosan can be administered after the consumption of an undesirable drug or an overdose of a drug so as to counteract the drug's effect.

Secondly, the chitosan and the drug compound can be administered simultaneously or sequentially to prolong the uptake of a drug. Thus it may be desirable to take the chitosan and said drug compound either simultaneously or prior to the consumption of the drug so as to maintain the drug concentration in the blood below a certain level. The medicament may also be used so as to provide sustained release of the drug and therefore the drug may act for a longer period of time.

Thus viewed from a further aspect the invention provides a pharmaceutical composition comprising chitosan having an F_{A} value of at least 0.25 and a drug compound, optionally together with at least one physiologically tolerable carrier or excipient.

The drug compound can for example be a lipophilic or amphiphilic, organic or organometallic species or a negatively charged species, again typically an organic or organometallic species. The drug compound can for example be warfarin or digitoxin. Typically the composition will be administered into the gastrointestinal tract, e.g. orally or rectally.

The administration form of the chitosan may typically be any form suitable for oral or rectal administration or administration directly into the stomach, e.g. tablets, coated tablets, capsules, powders, solutions, dispersions, suspensions, and gels. Tablets, capsules and solutions are preferred. These may be prepared using conventional pharmaceutical formulation acids, e.g. solvents (especially water), flavours, colorants, pH modifiers, viscosity modifiers, fillers, antioxidants, stabilizers, sweeteners, etc. The chitosan content of such compositions is preferably 5 to 98% wt, especially 20 to 90% wt, excluding the weight of any solvent or casing.

The dosage of chitosan given according to the invention will depend on the species, age, sex, and bodyweight of the subject being treated as well as on the nature of the compound the uptake of which is to be inhibited or prolonged and on whether the subject has an enhanced susceptibility to the effect of the compound. Generally however for an adult human subject the daily dosage may be in the range of 0.5 to 100 g, especially 1 to 10 g.

In the case of desired drug administration, the chitosan-based medicament will preferably be administered before, during or after meal times, especially within 45 minutes of the beginning or end of meal times.

It is believed that the beneficial effects of the chitosans in the compositions of the invention may arise from their pronounced ability to flocculate the lipids in oil in water emulsions. It is also believed that the beneficial effects of the chitosans in the compositions of the invention may arise from the ability of the compositions to flocculate the emulsifying agent (ie. SDS, bile salts and commercially available emulsifiers) in oil-in-water or water-in-oil emulsions, thereby destabilising the emulsion.

This ability is of use beyond the fields of foods and medicines, e.g. in techniques for separating lipids (e.g. oil from a hydrocarbon well or from an oil or petrol spillage) from water, e.g. sea-water. In such uses, the chitosan is preferably added to the lipid-water mixture and after a period for allowing flocculation to occur the flocculated lipid is removed from the water, e.g. by centrifugation, filtration, cyclone separation, decantation, skimming, or absorption onto an absorbent pad or the like.

Thus viewed from, a further aspect the invention provides the use of a chitosan having an F_{A} value of at least 0.25, preferably a chitosan having a weight average molecular weight of from 1 000 to 5 000 000 g/mol, more especially a chitosan having an F_{A} value of at least 0.3, particularly a chitosan or chitosan combination referred to above as being preferred, in the separation of lipids from water, especially hydrocarbons from water.

Viewed from a still further aspect the invention provides a process for the separation of lipids from water wherein a chitosan having an F_{A} value of at least 0.25, preferably a chitosan having a weight average molecular weight of from 1 000 to 5 000 000 g/mol, more especially a chitosan having an F_{A} value of at least 0.3, particularly a chitosan or chitosan combination referred to above as being preferred, is added to lipid-containing water (preferably hydrocarbon containing water), the lipid is allowed to flocculate and the flocculated lipid is separated off.

Typically the chitosan may be used at concentrations of 0.5 to 500 mg/L, especially 1 to 50 mg/L, particularly 2 to 20 mg/L.

The invention will now be illustrated further by reference to the following non-limiting Examples and the accompanying drawings in which:

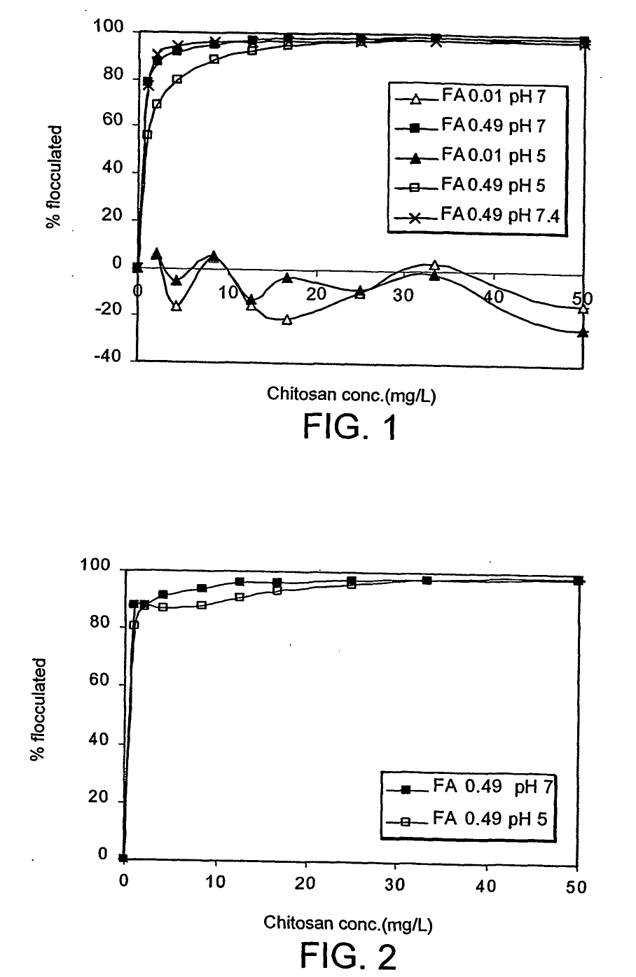

FIG. 1 is a plot of percentage of flocculation against chitosan concentration for chitosans of F_{A} 0.01 and 0.49 at pH 5.7 and 7.4; and FIG. 2 is a plot of percentage of flocculation against chitosan concentration for a low molecular weight chitosan of F_{A} 0.49 at pH 5 and 7.

### EXAMPLE 1

Chitosan Capsules

100 g chitosan F_{A} 0.46*
   lactose q.s.
      *-Prepared as described in WO 03/011912

Chitosan and lactose are mixed and filled in hard gelatin capsules. Each capsule contains 1 g chitosan.

Dose:

1-8 capsules to each meal
5-30 capsules if suspicion of poisoning

### EXAMPLE 2

Fried Potato Product Comprising Chitosan

250 kg chitosan F_{A} 0.30*
2250 kg dehydrated potato granulate
   water q.s.
      *-Prepared as described in WO 03/011912

Chitosan and dehydrated potato granulate are mixed. Water is added to form a formable mass. The potato mass is formed into the desired shape using conventional equipment. The formed pieces are then fried in vegetable oil and packed in commercial units of 100 g to 1 kg. The fried potato product contains more than 5% chitosan F_{A} 0.30.

### EXAMPLE 3

Lipid Flocculation

In relation to metabolism and adsorption of fat from the gastrointestinal tract it is essential that the fat occurs as an emulsion to increase the surface area of the fat droplets. One way to reduce fat digestion is by flocculation, e.g. when colloidal particles such as emulsified fat droplets form aggregates. The Example demonstrates the flocculation efficiency of chitosans with varying chemical composition (i.e. fraction of acetylated units, F_{A}). A model system of sunflower oil emulsions stabilized with Sodium-Dodecyl-Sulphate (SDS) was flocculated with different chitosans.

Three different chitosans were used. Chitosan 1 is a low-acetylated chitosan while Chitosan 2 and Chitosan 3 are more highly acetylated chitosans of different intrinsic viscosities ([η]) and thereby average molecular weights. The characteristics of the chitosans are given in Table 1 below.

TABLE 1

| Chitosan | F_{A}* | [η] (ml/g)** | Mₙ*** |
|---|---|---|---|
| Chitosan 1 | 0.01 | 800 | 250 000 |
| Chitosan 2 | 0.49 | 900 | 206 000 |
| Chitosan 3 | 0.49 | 220 | 49 000 |

*Determined according to V\dot{a}rum et al., 1991 (Carbohydr. Res. (1991)211 17-23)
**Determined according to Draget et al., 1992 (Biomaterials (1992) 13 635-638)
***Estimated from [η] = K × Mₙ (Anthonsen et al., 1993, Carbohydr. Polym. (1993) 22 193-201)

Water-in-oil emulsions of sunflower oil stabilized with Sodium-Dodecyl-Sulphate (SDS) were prepared as described below and increasing amounts of chitosans were added to the emulsions. The flocculation was quantified by measuring the decrease in turbidity of the solutions relative to a blank. FIG. 1 of the accompanying drawings shows the results of the flocculation experiments with Chitosan 1 (F_{A}=0.01) and Chitosan 2 (F_{A}=0.49) of comparable average molecular weights at pH 5 and 7. In addition, the flocculation of Chitosan 2 at pH 7.4 is shown. A pronounced difference in flocculation efficiency between the two chitosans is seen from the data in FIG. 1. While the chitosan with the highest F_{A} (0.49) flocculated sunflower oil emulsions stabilized with SDS at chitosan concentrations of less than 1 mg/L, the chitosan with the lower F_{A} (0.01) was still ineffective at concentrations of 50 mg/L. The same trend in the difference in flocculation efficiencies between the two chitosans was observed at pH 5 and 7. Chitosan 2 with the highest F_{A} (0.49) was more effective at pH 7 compared to pH 5, and this trend was even more pronounced at pH 7.4.

In order to evaluate if the molecular weight was critical to the flocculation efficiency of the chitosan with the highest F_{A} (0.49), this chitosan was depolymerized and the flocculation efficiency of the depolymerized chitosan (Chitosan 3) was tested at pH 5 and pH 7. The results are shown in FIG. 2 of the accompanying drawings and show that the depolymerized chitosan with F_{A} of 0.49 (Mₙ=49 000) is comparable in efficiency to the starting chitosan (Mₙ=206 000).

In conclusion, more highly acetylated chitosans were shown to be highly effective flocculants as compared to low-acetylated chitosans. The chain length was not a critical factor to their efficiencies as flocculants.

Chitosans:

Chitosan 1 was prepared as described by Anthonsen et al., Carbohydr. Polym. (1993) 22 193-201. Chitosan 2 was prepared by heterogeneous deacetylation, and Chitosan 3 was prepared by depolymerization of Chitosan 2 (see Anthonsen et al., Carbohydr. Polym (1993) 22 193-201). The chitosan-hydrochloride salts used in this study were prepared from chitosans in the free amine form by dialysis as described previously (Anthonsen et al., Carbohydr. Polym (1993) 22 193-201). Solutions of chitosans (1 mg/mL) were prepared by gentle shaking in MQ-grade water at 5° C. overnight and adjusted to ionic strength of 0.1 M with NaCl. They were further diluted with 0.1 M NaCl to the desired concentration series (6-1000 mg/L).

Emulsions:

Sunflower oil/water emulsions with Sodium-Dodecyl-Sulphate (SDS) as emulsifier were prepared by the use of Ultraturrax (IKA, Germany) at 24 000 rpm for 2 min. The sunflower oil content of the emulsions was 3 wt % and the total amount of emulsifier was 3 wt % of the oil phase. Emulsions with 3 different pH values (5, 7 and 7.4) were prepared, using 50 mM acetate (pH 5) or HEPES (pH 7 and 7.4) buffers as the water phase. The ionic strength of the buffers was adjusted to 0.1 M with NaCl.

Flocculation Procedure:

The flocculation assay was performed in 13 mL polypropylene tubes (Saratedt). 5 mL of emulsion was pipetted into the tubes, and 1 mL of chitosan solution was added under stirring on a Vortex mixer (1800 rpm, 10 s) to ensure proper mixing. A corresponding blank was prepared with 1 mL of 0.1 M NaCl. When the whole concentration series was prepared, the tubes were again mixed on a Vortex mixer (1400 rpm, 5 s). After 120 min a sample for optical density (OD) measurement was withdrawn from the middle of the tube. The OD of the samples were measured at 620 nm on a spectrophotometer, zero-set against the actual buffer. The flocculation was expressed as the decrease in turbidity relative to blank (referred to as % flocculated), calculated as
(1−(OD sample/OD blank))*100.

All samples were run in duplicate.

### EXAMPLE 4

Effect of Chitosans on Availability of Cholesterol

Cholesterol (500 mg) and chitosan (various degrees of acetylation) (2.0 g) were added to a diluted aqueous HCl solution pH 2 (250 ml). The mixture was stirred at room temperature for 2 hours. An aqueous solution of NaOH was added dropwise to pH 7 and the mixture was stirred for 4 hours at room temperature. The mixture was extracted with diethyl ether (100 ml), the ether solution was dried (MgSO₄) and evaporated.

An experiment without chitosan was performed as a comparison. The results are shown in Table 2.

TABLE 2

| Experiment No. | Chitosan | Yield cholesterol |
|---|---|---|
| 1 | F_{A} = 0.19, η = 610 | 160 mg (32%) |
| 2 | F_{A} = 0.46, η = 1230 | 60 mg (12%) |
| 3 | no chitosan | 440 mg (88%) |

### EXAMPLE 5

Effect of Chitosans on Availability of Acrylamide

Acrylamide (500 mg) and chitosan (various degrees of acetylation) (2.0 g) were added to a diluted aqueous HCl solution pH 2 (250 ml). The mixture was stirred at room temperature for 2 hours. An aqueous solution of NaOH was added dropwise to pH 7 and the mixture was stirred for 4 hours at room temperature. The mixture was extracted with ethyl acetate (200 ml), the organic phase was dried (MgSO₄) and evaporated. The results are shown in Table 3.

TABLE 3

| Experiment No. | Chitosan | Yield acrylamide |
|---|---|---|
| 1 | F_{A} = 0.19, η = 610 | 150 mg (30%) |
| 2 | F_{A} = 0.46, η = 1230 | 50 mg (10%) |

### EXAMPLE 6

Effect of Chitosan on Availability of Warfarin

Marevan® tablets from Nycomed Pharma AS (Oslo, Norway) (2.5 mg) were crushed with morter and pestle to a powder. The powder containing 83 mg warfarin and chitosan (various degrees of acetylation) (250 mg) were added to a diluted aqueous HCl solution pH 2 (10 ml). The mixture was stirred for 2 hours at 80° C., cooled to room temperature and dialysed against tris buffer pH 7 (100 ml). The amounts of warfarin in dialysate was determined by UV.

The amounts of warfarin in the dialysate are shown as a percentage of maximum detected amounts The results are shown in Table 4.

TABLE 4

| Time for dialysis | Chitosan | Chitosan |
|---|---|---|
| (hours) | F_{A} = 0.19, η = 610 ml/g | F_{A} = 0.35, η = 1250 ml/g |
| 0.25 | 30 | 20 |
| 0.5 | 27 | 20 |
| 1 | 45 | 29 |
| 2 | 43 | 36 |
| 4 | 38 | 40 |
| 16 | 100 | 59 |

### EXAMPLE 7

Effect of Chitosan on Availability of Norfloxacin

Norfloxacin (100 mg) and chitosan (F_{A}=0.35, η=1250) (250 mg) were added to a diluted aqueous HCl solution pH 2 (10 ml). The mixture was stirred for 2 hours at 80° C., cooled to room temperature and dialysed against tris buffer pH 7 (100 ml). The amount of norfloxacin in dialysate was determined by UV.

An experiment without chitosan was performed as a comparison.

The amounts of norfloxacin in dialysate are shown as a percentage of maximum detected amounts. The results are shown in Table 5.

TABLE 5

| Time for dialysis | | |
|---|---|---|
| (hours) | Without chitosan | With chitosan |
| 0.25 | 66 | 48 |
| 0.5 | 72 | 72 |
| 1 | 100 | 93 |
| 2 | 100 | 100 |
| 4 | 100 | 100 |

1. A foodstuff comprising a nutritional food substance and a chitosan having an F_{A} value greater than 0.40.

2. The foodstuff as claimed in claim 1, wherein said nutritional food substance is a cooked or uncooked material of animal or plant origin.

3. The foodstuff as claimed in claims 1 or 2, comprising a chitosan having a weight average molecular weight of from 1,000 to 5,000,000 g/mol.

4. The foodstuff as claimed in claims 1 or 2, comprising a chitosan having a weight average molecular weight of from 20,000 to 2,000,000 g/mol.

5. The foodstuff as claimed in claim 1, comprising a chitosan fully water-soluble at a pH of 3 to 8.

6. The foodstuff as claimed in claim 1, comprising a chitosan having an F_{A} value of up to 0.9.

7. The foodstuff as claimed in claim 1, comprising a chitosan having an F_{A} value of up to 0.7.

8. The foodstuff as claimed in claim 1, comprising a chitosan fully water-soluble at a pH of 5 to 8.

9. The foodstuff as claimed in claim 1, comprising a chitosan fully water-soluble at a pH of 6 to 8.

10. The foodstuff as claimed in claim 1, comprising a combination of at least two chitosans with different F_{A} values.

11. The foodstuff as claimed in claim 10, wherein the F_{A} values of said chitosans differ by at least 0.1.

12. The foodstuff as claimed in claims 10 or 11, wherein the F_{A} values of said chitosans differ by at least 0.2.

13. The foodstuff as claimed in claim 10, comprising one or more chitosans with an F_{A} value below 0.40.

14. The foodstuff as claimed in claim 10, comprising one or more chitosans with an F_{A} value below 0.25.

15. The foodstuff as claimed in claim 1, further comprising a lysozome.

16-19. (canceled)

20. A pharmaceutical composition comprising chitosan having an F_{A} value greater than 0.40 and a drug compound, optionally together with at least one physiologically tolerable carrier or excipient.

21. The composition as claimed in claim 20, wherein said drug compound is a negatively charged species.

22. A The composition as claimed in claim 20, wherein said drug compound is a lipophilic or amphiphilic organic or organometallic species.

23. The composition as claimed in claim 20 in a form adapted for oral or rectal administration.

24. The composition as claimed in claim 20, wherein said drug compound is selected from warfarin and digitoxin.

25. A method of treatment of a human or non-human vertebrate subject to inhibit uptake from the gastrointestinal tract thereof of undesired chemical compounds, which method comprises administering orally to said subject an effective amount of a chitosan having an F_{A} value greater than 0.40.

26. The method as claimed in claim 25, wherein said non-human vertebrate is a mammal.

27. The method as claimed in claim 26, wherein said chemical compound is a negatively charged or neutral toxin.

28. The method as claimed in claim 26, wherein said compound is selected from the group consisting of warfarin and digitoxin.

29. The method as claimed in claim 25, wherein chitosan is administered in the gastrointestinal tract.

30. A method of treatment of a human or non-human vertebrate subject to inhibit uptake thereby of a drug compound, said method comprising administering to said subject simultaneously or sequentially to the same body duct or cavity or tissue an effective amount of said drug compound and of a chitosan having an F_{A} value greater than 0.40.

31. The method as claimed in claim 30, wherein administration is into the gastrointestinal tract.

32. The method as claimed in claim 30, wherein said drug compound is a negatively charged, lipophilic or amphiphilic species.

33-37. (canceled)

38. A process for the separation of lipids from water, wherein a chitosan having an F_{A} value greater than 0.40 is added to lipid-containing water, the lipid is allowed to flocculate and the flocculated lipid is separated off.

39. The process as claimed in claim 38, wherein said chitosan has a weight average molecular weight of from 1,000 to 5,000,000 g/mol.

40. The process as claimed in claim 38, wherein a combination of at least two chitosans with different F_{A} values is used.
